(19) United States
(12) Patent Application Publication
(10) Pub. No.: US 2024/0394522 A1
(43) Pub. Date: Nov. 28, 2024

(54) HIERARCHY DRIVEN TIME SERIES FORECASTING

(71) Applicant: INTERNATIONAL BUSINESS MACHINES CORPORATION, Armonk, NY (US)

(72) Inventors: Vijay Ekambaram, Chennai (IN); Nam H. Nguyen, Pleasantville, NY (US); Arindam Jati, Bengaluru (IN); Phanwadee Sinthong, White Plains, NY (US); Pankaj Satyanarayan Dayama, Bangalore (IN); Jayant R. Kalagnanam, Briarcliff Manor, NY (US)

(21) Appl. No.: 18/200,642

(22) Filed: May 23, 2023

(51) Int. Cl. G06N 3/0499

(52) U.S. Cl. CPC G06N 3/0499

(57) ABSTRACT

A method for lightweight and efficient long sequence time-series forecasting and representation learning includes segmenting a time-series dataset from a plurality of sensors into a plurality of patches. The method further includes applying gated multilayer perceptron (MLP) mixing across different directions of the patched input time-series. The method further includes capturing local and global and interrelated correlations across the plurality of patches and within the plurality of patches. The method further includes applying a patch-time aggregated hierarchy to guide lowest-level predictions based on aggregated hierarchy signals at a patch-level. The method further includes chaining MLP-mixers in a patch length context aware hierarchy fashion to enhance time-series short and long-term correlation capture.

### BACKGROUND

Smart sensors are an integral part of the current movement to increasingly automate (and make increasingly interconnective) various devices within myriad realms, such as industrial realms and/or commercial realms. These smart sensors enable additional functionalities from self-monitoring to predictive maintenance. The data collected over time from these sensors is often collected as part of a multivariate time series. Using data that is part of a multivariate time series, various governance components (e.g., a computer system that controls or otherwise monitors various local remote systems) can analyze the state of numerous systems that comprise a given industrial and/or commercial system. For example, a governance component may forecast future values of the time series to enable operators of the system to perform necessary maintenance ahead of time to reduce the potential downtime, reduce a drop of efficiency (caused by parts that are due for maintenance), reduce a total cost by avoiding a larger scale system failure, or the like.

As such, as more devices with more smart sensors get added to these systems that require the above analysis (and often also require corresponding action), the demands upon governance components have grown in kind. However, the ability of robust time-series models to comprehensively address these increasing demands has been insufficient at meeting this growing demand. For example, many governance components utilize time-series based transformers that have self-attention networks with quadratic memory and timing requirements that makes it difficult (if not practically impossible) to use these transformers for long term forecasting with acceptable degrees of accuracy absent impractical devotion of computing resources.

This shortcoming comes from a variety of challenges. For example, as compared to other applications such as natural language processing (NLP) or vision, in the smart sensor realm there is a distinct lack of labeled or unlabeled data that is available for use as training data for the models that are to process the multivariate time series data. This is problematic as a lack of training data has a strong correlation with resultant models (e.g., the models that are trained on that insufficient training data) generally having lower degrees of accuracy for their predictions/classifications. For another example, the quality of data coming from time series of sensors is often relatively poor. Specifically, sensor data tends to be particularly noisy as most widely spread internet-of-things (IoT) environments contain a number of sensors that capture a wide spread of phenomenon. When the training data and/or the “live” data is particularly noisy, the resultant system has a greater chance of learning inaccurate associations (during training) and also subsequently identifying false negatives or false positives from outlier data.

In addition to the sensor data being noisy, IoT environments that utilize smart sensors frequently end up with a significant number of “missing” data points, as compared to other real-time data series such as with NLP or vision applications. For example, for a given NLP or vision application, the location of the relevant data that needs to be gathered is often easy to define, and therefore it is easy to make sure that all of that data is eventually gathered for analysis. Comparatively, given the widespread and divergent data which smart-sensor applications tend to look for, it can be significantly more difficult to guarantee that all/most of the useful data is predefined for eventual gathering.

For yet another example, in many applications there is a spatial aspect to sensor data that current NLP and vision governance systems are not equipped to identify, much less leverage to arrive at improved conclusions. For example, in some smart sensor applications there may be value in identifying (and therein analyzing) a distance and timing at which various phenomenon is captured, such that what is important is not necessarily “only” what one individual sensor gathered, but what numerous sensors at numerous different locations captured over an identified time duration. For these (and other) reasons, while numerous systems exist that are capable of inputting the type of data that can be output by a significant sensor array, these systems tend to perform relatively poorly at analyzing this sensor data.

### SUMMARY

Aspects of the present disclosure relate to a method, system, and computer program product relating to lightweight and efficient long sequence time-series forecasting and representation learning. For example, the method includes segmenting a time-series dataset from a plurality of sensors into a plurality of patches. The method further includes applying gated multilayer perceptron (MLP) mixing across different directions of the patched input time-series. The method further includes capturing local and global and interrelated correlations across the plurality of patches and within the plurality of patches. The method further includes applying a patch-time aggregated hierarchy to guide lowest-level predictions based on aggregated hierarchy signals at a patch-level. The method further includes chaining MLP-mixers in a patch length context aware hierarchy fashion to enhance time-series short and long-term correlation capture.

A system and computer program configured to execute the method described above are also described herein.

Moreover, aspects of the method, system, and computer program product described herein provide solutions to problems found in conventional systems. For example, conventional systems suffer from a lack of pretraining unlabeled data for the respective time series applications. However, aspects of this disclosure relate to utilizing simulated data and/or data from unrelated domain for pretraining.

For another example, conventional systems suffer from data noise and missing data that is intrinsic to smart sensor systems, such that there is a dearth of learned representations that are noise tolerant. Aspects of this disclosure relate to methods of smoothing data and quantization of data within the representation space to address the noisy data and account for missing data.

For another example, conventional systems fail to identify, much less account for, a spatial and temporal way in which the time series is interrelated. Aspects of the present disclosure relate to a new design of a transformer that is configured to capture temporal and spatial information as encoded within the signal. Therein, aspects of the disclosure can leverage spatial information across variables and temporal information within each series to improve a performance of downstream tasks (e.g., classification and/or prediction tasks done with a model that is trained on or otherwise fed the time series data).

For another example, conventional systems have a problem in which they fail to account for distribution shift, in which non-stationarity of elements of the system can cause distribution shift between the data used for pretraining and data used for downstream tasks. Aspects of this disclosure solve or otherwise address these shortcomings of conventional systems by pretraining the model on a very large amount of data.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a high-level architecture of a model that may realize lightweight and efficient long sequence time-series forecasting and representation learning.

FIG. 2A depicts an example channel-independent backbone that can be used in the example architecture of FIG. 1.

FIG. 2B depicts an example multilayer perceptron (MLP) Mixer layer for the architecture of FIG. 1.

FIG. 3 depicts a representation of example of chaining MLP-mixers in a patch length context aware hierarchy fashion to further improve long term & short-term correlation capture.

FIG. 4 depicts an example online hierarchical patch reconciliation head.

FIG. 5 depicts an example MLP block.

FIG. 6 depicts an example gated attention block.

FIG. 7 depicts an example prediction and pretrain head.

FIG. 8 depicts a table of results comparing forecasting results of an experiment using architecture of this disclosure against other conventional solutions.

FIG. 9 depicts a table of results comparing computational efficiency results of an experiment using architecture of this disclosure against other conventional solutions.

FIG. 10 depicts a conceptual box diagram of a computing system that may host and/or include the architecture of FIG. 1.

While the invention is amenable to various modifications and alternative forms, specifics thereof have been shown by way of example in the drawings and will be described in detail. It should be understood, however, that the intention is not to limit the invention to the particular embodiments described. On the contrary. the intention is to cover all modifications, equivalents, and alternatives falling within the spirit and scope of the invention.

### DETAILED DESCRIPTION

Aspects of the present disclosure relate to processing smart sensor data, while more particular aspects of the disclosure relate to lightweight and efficient long sequence time-series forecasting and representation learning. While the present disclosure is not necessarily limited to such applications, various aspects of the disclosure may be appreciated through a discussion of various examples using this context.

As described above, smart sensors are being increasingly utilized to interconnect and automate various devices within myriad realms, such as industrial realms and/or commercial realms. These smart sensors are used to get these devices to work independently or in conjunction in a desired manner. Data collected from these sensors over time is typically collected as part of a multivariate time series, where this time series is therein analyzed to monitor and/or control some or all of these devices. This may include rapidly responding to what is happening or predicting what is about it to happen, and therein suggesting and/or automating actions to take advantage of or otherwise address what is (currently or predicted to be) happening.

Conventional systems typically used one or more time-series based transformers to handle the multivariate time series. However, conventional time-series based transformers utilize self-attention networks with quadratic memory and timing requirements that make it difficult if not impossible to consistently use these conventional time-series based transformers for long-term forecasting. For example, it is difficult if not impossible for conventional time-series based transformers to have a robust accounting for longer history offsets and/or longer history forecasts.

One example of a modern smart sensor application may include an energy application in which sensors capture temperature data, flow data, pressure data, output data, and the like across a massive volume of pipes, physical components, output ports, and the like. A system may gather data from this energy environment for a matter of months or years (e.g., 24 months), where data is gathered approximately once a minute across this duration. As would be understood by one of ordinary skill in the art, the general output of the energy environment is directedly related to input and interrelations of the energy environment. However, even with this direct relation, a task to model the output given conventional solutions would be extremely difficult for numerous reasons. These reasons include the spatial correlation between data (e.g., the need to weight/account for data differently depending upon wherein the physical environment it was gathered). The reasons also include the lag between how different inputs at different times impact the output at different respective times, and the notable differences between the coarseness and fineness of data of the sensors (e.g., where some sensors can detect minute changes of temp/pressure/flow, and other sensors are only able to detect relatively significant changes of temp/pressure/flow).

As such, a conventional system receiving this data of an energy system and attempting to model the output may end up with a particularly inaccurate model that fails to capture and/or account for numerous factors present within this system. Further, while an energy system was used herein, aspects of this disclosure are applicable to any system where a plurality of smart sensors are used within a physical environment that is spread across a significant area (e.g., a full room, a full building, or a building complex) where this data is captured as a time series. For example, in other examples aspects of this disclosure relate to a system regarding the manufacture and delivery of milk powder, where some sensors gather data for a liquid feed, other sensors gather data relating to hot air that is mixed with the liquid feed, other sensors gather data relating to a tower in which the hot air and liquid feed is mixed, other sensors gather data regarding the packaging of the milk powder, and a final set of sensors gather data regarding the state of the milk powder at the point of sale, where all of this data from all of these sensors are turned into a multivariate time series for analysis.

Aspects of this disclosure may solve or address these problems via lightweight and efficient long sequence time-series forecasting and representation learning. For example, aspects of this disclosure relate to employing simulated data and/or data from unrelated domains for pretraining, smoothing and quantization in the representation space, new designs of transformers to capture special-temporal signal, and pretraining the model on a very large amount of data.

For example, aspects of the disclosure may relate to segmenting a gathered time-series into patches. Once the time-series is in patches, aspects of the disclosure apply gated Multilayer Perceptron (MLP) mixing. In some examples, aspects of the disclosure execute this MLP mixing in a channel independent way across different directions of the patched input time-series. Mixing in a channel independent way across different directions means alternating with respect to patches and features. By mixing in this manner, aspects of this disclosure are able to capture local and global interrelated correlations across and within patches and features. The method further includes applying a patch-time aggregated hierarchy to guide lowest-level predictions based on aggregated hierarchy signals at a patch-level. From this, the lowest-level predictions may be guided based on aggregated hierarchy signals at a patch-level. The method further includes chaining MLP-mixers in a patch length context aware hierarchy fashion to enhance time-series short and long-term correlation capture.

As specifically related to what may be considered a leading conventional solution for patch based time series forecasting/representation—PatchTST (A Time Series is Worth 64 Words: Long-term Forecasting with Transformers, https://arxiv.org/abs/2211.14730])—aspects of this disclosure perform favorably, as discussed herein. In comparison to PatchTST, aspects of this disclosure replace the transformer encoder with a customized MLP Mixer right in a “backbone” of the architecture as discussed herein. Beyond this, as compared to PatchTST, aspects of this disclosure finetune respective heads with aggregated hierarchy signals as discussed herein.

Moving to a more detailed discussion of aspects of this disclosure, multivariate time series forecasting includes predicting the future values of multiple time series at future time points given the historical values of those time series. In many instances, some or all of these time series may be related, though the specific nature of this relationship may be unknown when the time series are gathered.

Multivariate time series forecasting has widespread applications, such as weather forecasting, traffic prediction, industrial process controls, etc. Conventional transformer-based models are becoming popular for long-term multivariate forecasting due to their powerful capability to capture long-sequence dependencies. Several transformer architectures have been developed with this task in mind, and in some fields (such as natural language processing (NLP)), some of these transformer architectures have been identified as being highly successful. Specifically, in NLP, transformer architectures have been designed to leverage the consistently structured and semantically rich natural language domain in which they function to perform with high degrees of accuracy in downstream applications.

This success has not translated to the time series domain. One of the possible reasons is that, though positional embedding in transformers preserves some ordering information, the nature of the permutation-invariant self-attention mechanism inevitably results in temporal information loss. This concept has been validated in studies where a simple linear DLinear (Are Transformers Effective for Time Series Forecasting?, https://arxiv.org/pdf/2205.13504.pdf) model is able to outperform many transformer architectures developed for other applications.

Moreover, unlike words in a sentence, an individual time point in a time series does not contain much semantic information and often can be easily interpolated from its neighbors. Hence, a significant amount of modeling capability is wasted in learning fine-grained point-wise information in the time series when a transformer is trained with point-wise input tokens. Some conventional transformer-based models have addressed this bottleneck by segregating the input time series into a finite number of patches and then feeding these patches into the transformer model.

In some examples, a channel-independent can improve performance compared to a simple channel mixing approach (e.g., an approach that utilizes a simple concatenation of channels before feeding into the model). This is because a simple mixing approach can produce noisy interaction between channels at the very first layer of the transformer, where these noisy interactions will be difficult to decouple at output. In addition, though some conventional transformer-based models reduce the timing and memory overhead via patching, such conventional transformer-based models use the multi-head self-attention under the hood, which is computationally expensive even when it is applied at the patch level.

Beyond this, multi-layer perceptron (MLP) such as “MLP-Mixers” have been proposed in the computer vision domain (MLP-Mixer: An all-MLP Architecture for Vision, https://arxiv.org/abs/2105.01601) as disclosed herein are lightweight and fast, and tend to eliminate the need for computing intense multi-head self-attention. Moreover, MLP-Mixers, by their default architecture, tend to avoid disturbing the temporal ordering of the inputs which makes MLP-Mixers a natural fit for time-series problems, particularly as they resolve the concerns raised in DLinear.

Aspects of this disclosure relate to using MLP-Mixer models to yield superior performance for multivariate time series forecasting. The adoption of MLP-Mixer for time series is not trivial, as applying the vanilla MLP-Mixer with some input and output shape modification will not result in a powerful model, but will instead have suboptimal performance compared to conventional solutions. Rather, aspects of this disclosure relate to a novel MLP-Mixer architecture for accurate multivariate time series forecasting. The architecture disclosed herein is patching-based and follows a modular architecture of learning a common “backbone” to capture the temporal dynamics of the data as a patch representation, wherein different “heads” are attached and finetuned based on various downstream tasks (e.g., forecasting). The backbone is considered task-independent and can learn across multiple datasets with a masked reconstruction loss while the heads are task and data-specific.

There are numerous noteworthy elements of the architecture disclosed herein. For example, the architecture disclosed herein is a patching-based, lightweight neural architecture designed with MLP modules that exploit various inherent time-series characteristics for accurate multivariate forecasting and representation learning. The architecture also includes attaching and tuning online hierarchical reconciliation head to the MLP-Mixer backbone. In this way, the architecture converts the learning capability of simple MLP structures to outperform complex transformer models with significantly less computing resources. “Reconciliation,” as used herein, is different from the standard reconciliation in hierarchical forecasting, such that reconciliation as used herein targets patch-aggregation and is done online during training. Further, “online” means that learning is part of the overall loss computation and not as a separate offline process. The architecture also includes chaining MLP-mixers in a patch length context aware hierarchy fashion to enhance time-series short and long-term correlation capture.

Yet another feature of the architecture disclosed herein includes long sequence modeling via simple gated attention that guides the model to focus on important features. This, when augmented with a hierarchical patch reconciliation head and “standard” MLP-Mixer, the presented architecture enables effective modeling of long-sequence interaction and reduces (if not eliminates) the need for complex multi-head self-attention blocks. Finally, another feature of the architecture disclosed herein is a modular design that enables working with both supervised and masked self-supervised learning methodologies which makes aspects of this disclosure a potential building block for time-series foundation models.

Further, as shown herein, aspects of this disclosure (when used on seven popular public datasets recited below) outperformed all existing benchmarks with extremely reduced training time and memory usage.

Throughout the paper, the following variable names are used:
X_{c×L}: a multivariate time series of length L and c channels or c time series;
sl≤L: input sequence length;
fl: forecast sequence length (a.k.a. horizon);
b: batch size;
n: number of patches;
pl: patch length;
hf: hidden feature dimension;
ef: expansion feature dimension;
nl: number of MLP-Mixer layers;
M: learned DNN model;
op: number of output forecast patches;
cl: context length;
Ĥ: patch-aggregated prediction;
H: patch-aggregated ground truth;
Ŷ_{rec}: actual base prediction;
Y_{rec}: base ground truth; and
sf: scale factor.
   As used herein, the shape of a tensor is recited as the subscript in the text, and is presented in square brackets in the Figures. A linear layer in the neural network is denoted by A(⋅) for compactness.

The multivariate forecasting task is defined as predicting future values of the time series given some history:

$${\hat{Y}}_{fl \times c} = M ( {X}_{sl \times c} )$$

The ground truth future values will be denoted by Y_{fl×c}.

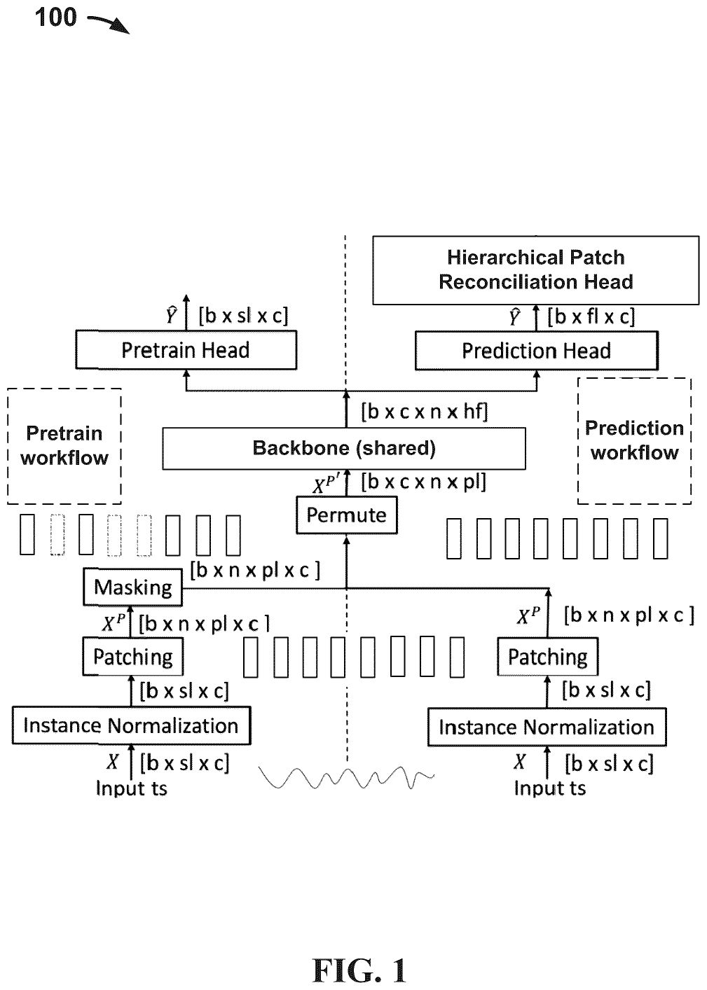

The architecture disclosed herein may utilize both supervised and self-supervised training methodologies. The supervised training follows the “prediction” workflow as shown in the right part the high-level architecture 100 of FIG. 1. First, a model puts the input history time series through a sequence of transformation (e.g., normalization, patching, and permutation). Then, the model sends this data through the backbone which is responsible for the main learning process. The prediction head converts the output embeddings of the backbone to the base forecasts, Ŷ. The model can be trained to minimize the mean squared error (MSE) of the base forecasts: L(Y, Ŷ=∥Y−Ŷ∥₂².

Also introduces an online hierarchical reconciliation head which, if activated, can tune the base forecasts and produce more accurate forecasts by leveraging patch-aggregation information. When this reconciliation head is activated, a customized MSE-based objective function is employed on the tuned forecasts. A detailed discussion is provided below. The self-supervised training is performed in two stages. First, the model is pretrained (see the “pretrain” workflow in FIG. 1) with a self-supervised objective. Then, the pretrained model is fine-tuned through the “prediction” workflow for a supervised downstream task. Self-supervised pretraining is useful for a variety of NLP, vision, and time series tasks. Similar to a bidirectional encoder representations from transformer's (BERT's) masked language modeling (MLM) in the NLP domain, employed herein is a masked time series modeling (MTSM) task. The MTSM task randomly applies masks on a fraction of input patches, and the model is trained to recover the masked patches from the unmasked input patches. Other input transformations in the pretrain workflow are the same as in the prediction workflow. The MTSM task minimizes the MSE reconstruction error on the masked patches. The modular design of the disclosed architecture enables either supervised or self-supervised training by only changing the model head (and keeping backbone the same).

Numerous modeling components are introduced to a vanilla MLP-Mixer to realize improved performance from the high-level architecture is shown in FIG. 1. For stochastic gradient descent (SGD), each minibatch (X^{B}_{b×sl×c}) is populated from X by a moving window technique. The forward pass of a minibatch along with its shape is shown in FIG. 1.

From here, the input time series segment goes through reversible instance normalization (RevIN). RevIN standardizes the data distribution (i.e., removes mean and divides by the standard deviation) to tackle data shifts in the time series. After this, every univariate time series is segregated into overlapping/non-overlapping patches with a stride of s. For self-supervised training flow, patches have to be strictly non-overlapping. The minibatch X^{B}_{b×sl×c} is reshaped into X^{P}_{b×n×pl×c} where pl denotes the patch length, and n is the number of patches (hence, n=└(sl−pl)/s┘+1). The patched data is then permuted to X_{b×c×n×pl}^{P′} and fed to the architecture backbone model. Patching reduces the number of input tokens to the model by a factor of s, and hence, increases the model runtime performance significantly as compared to standard point-wise Transformer approaches.

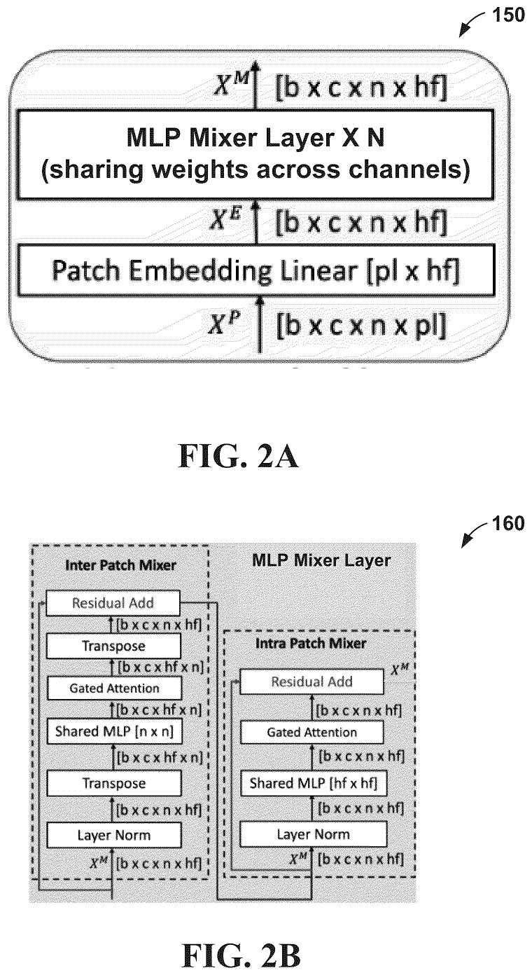

FIG. 2A represents the channel independent backbone 150 which shares model weights across channels. This results in reduction of model parameters, in addition to helping modelling self-supervised approaches with datasets having varying channel sizes.

Note that all the channel independent backbone 150 starts with a linear patch embedding layer as shown in FIG. 2A which transforms every patch independently into an embedding: X_{b×c×n×hg}^{E}=A(X^{P′}). The weight and bias of A(⋅) are shared across channels for backbone 150.

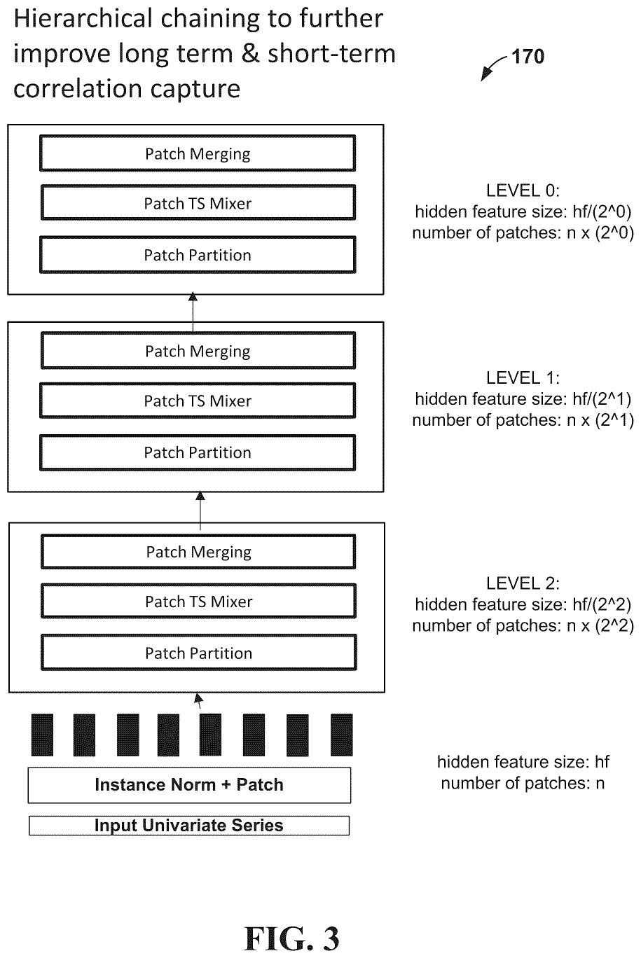

The backbone 150 then stack a set of mixer layers like encoder stacking in transformers. We can either do normal stacking as depicted in FIG. 2A or we can do hierarchical chaining of stacks as depicted in FIG. 3. In Hierarchical chaining of MLP-mixers, as we increase the hierarchy stack level, the number of patches (n) which the mixer model inputs increases while the number of hidden features decreases. Depicted is a patch partition and patch merging layer between mixer layer which increase and/or decrease the number of patches and hidden feature size. Every stacked block initially has a patch partition layer which splits the patches based on the level number and passes it to the MLP-Mixer for modelling. From here, the output from the MLP-mixing is again reshaped to its original shape using patch merge layers. For example, if the hierarchical stack level is i, then i levels exist with each level having n_layers. Level id starts with 0 which represents the last block chained in the hierarchy. From this point, num_patches (n) at level i will be multiplied by (2\hat{ }i) and num_features (hf) at level i will be divided by (2\hat{ }i). Thus, the granularity of operations various across the MLP mixer layers in various hierarchy levels leads to better modelling.

For Ex. if 3 stack levels exist, then the resolution of mlp-mixing operation at each level is as follows:
level 2 (bottom block): num_features//(2\hat{ }2), num_patches*(2\hat{ }2)
level 1 (middle block): num_features//(2\hat{ }1), num_patches*(2\hat{ }1)
level 0 (top block): num_features//(2\hat{ }0), num_patches*(2\hat{ }0)
   Chaining MLP-mixers in a patch length context aware hierarchy fashion greatly helps to enhance time-series short and long-term correlation capture.

Details of the Mixer layers 160 are depicted in FIG. 2B which are configured to learn correlations across two different directions: (i) between different patches, and (ii) between the hidden feature inside a patch. The inter patch mixer module employs a shared MLP (weight dimension=n×n) to learn correlation between different patches. The intra patch mixer block's shared MLP layer mixes the dimensions of the hidden features, and hence the weight matrix has a dimension of hf×hf.

The input and output of the mixer layers and mixer blocks are denoted by X_{b×c×n×hf}^{M}. Based on the dimension under focus in each mixer block, the input gets reshaped accordingly to learn correlation along the focused dimension. The reshape gets reverted in the end to retain the original input shape across the blocks and layers. All of the two mixer modules are equipped with an MLP block, layer normalization, residual connection, and gated attention. The former three components are standard in MLP-Mixer while the gated attention block is described below. MLP block 190 is depicted in FIG. 5.

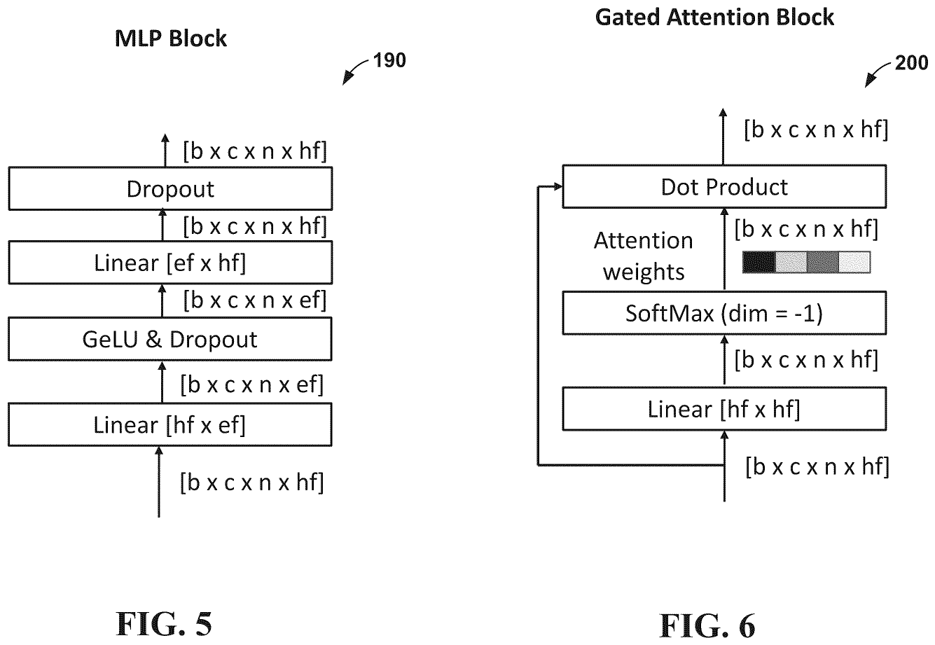

Time series data often has a lot of unimportant features that confuse the model. In order to effectively filter out these features, a simple gated attention is added after the MLP block in each mixer component. GA acts like a simple gating function that probabilistically upscales the dominant features and downscales the unimportant features based on its feature values. The attention weights may be derived by: W_{b×c×n×hf}^{A}=softmax(A(X^{M})). The output of the gated attention module is obtained by performing a dot product between the attention weights and the hidden tensor coming out of the mixer modules: X^{G}=W^{A}·X^{M}. Augmenting GA with standard mixer operations effectively guides the model to focus on the important features leading to improved long-term interaction modeling, without requiring the need for complex multi-head self-attention. GA block 200 is depicted in FIG. 6.

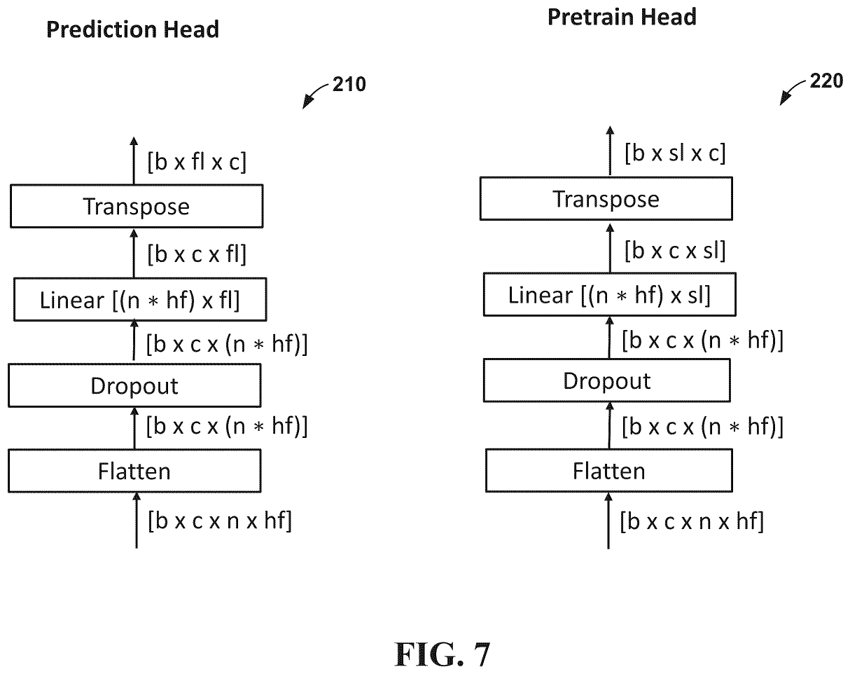

Based on the training methodology (i.e., supervised or self-supervised), either prediction or pretrain heads are added to the respective backbone. Both heads employ a simple linear layer with dropout after flattening the hidden features across all patches. By default, these heads share the same weights across channels. The output of the prediction head is the predicted multivariate time series (Ŷ_{b×fl×c}), while the pretrain head emits a multivariate series of the same dimension as the input (\hat{X}_{b×sl×c}). An example prediction head 210 and pretrain head 220 are depicted in FIG. 7

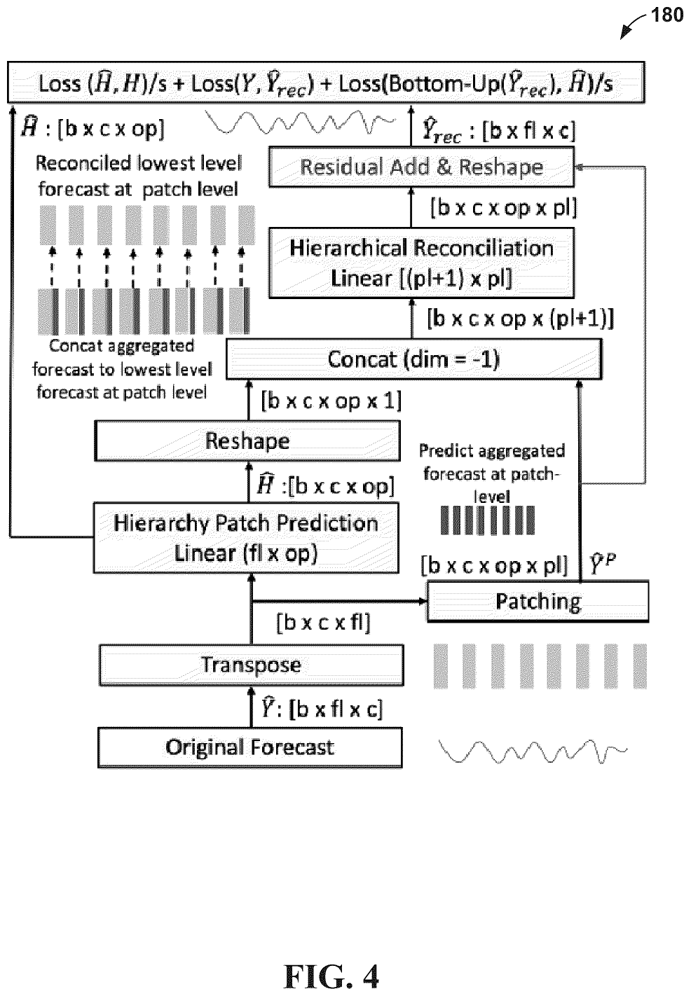

Aspects of this disclosure also relate to an online hierarchy patch reconciliation head 180 as depicted in FIG. 4. Time series data often possess an inherent hierarchical structure, either explicitly known (e.g., hierarchical forecasting datasets), or as an implicit characteristic (e.g., an aggregation of weather forecasts for seven days denotes an estimate of weekly forecast, an aggregation of sales forecast over all stores in a state denotes state-level sales, and so on). In general, aggregated time series have better predictability and a good forecaster aims at achieving low forecast error in all levels of the hierarchy. Here, aspects of this disclosure automatically derive a hierarchical patch aggregation loss (online during training) that is minimized along with the granular-level forecast error.

The original forecast Ŷ is segregated into op number of patches, each of length pl. This is denoted as Ŷ^{P}. Now, Ŷ is also passed through a linear layer to predict the hierarchically aggregated forecasts at the patch-level: Ĥ_{b×c×op}=A(Ŷ_{b×c×fl}). Then, Ŷ^{P} and Ĥ are concatenated at the patch level and passed through another linear transformation to obtain reconciled granular-level forecast: Ŷ_{rec}. Thus, the granular-level forecasts get reconciled at a patch level based on the patch-aggregated forecasts leading to improved granular level forecasts. Residual connections ensure that the reconciliation does not lead to accuracy drops in scenarios when predicting aggregated signals become challenging. Now, the hierarchical patch aggregation loss is calculated as follows:

$${L}_{hier} = \frac{1}{sf} L ( \hat{H} , H ) + L ( Y , {\hat{Y}}_{rec} ) + \frac{1}{sf} L ( BU ( {\hat{Y}}_{rec} ) , \hat{H} )$$

Where Y is ground-truth future time series, H is the aggregated ground-truth at patch-level, BU refers to bottom-up aggregation of the granular-level forecasts to obtain the aggregated patch-level forecasts, and sf is scale factor. For MSE loss, sf=(pl)². More intuitively, this loss tries to tune the base forecasts in a way such that they are not only accurate at the granular-level, but also accurate at the aggregated patch-level. Note that a pre-defined dataset-specific hierarchical structure can be enforced here.

TABLE 1
Statistics of popular datasets for benchmark.

| Datasets | Weather | Traffic | Electricity | ETTH1 | ETTH2 | ETTM1 | ETTM2 |
|---|---|---|---|---|---|---|---|
| Features | 21 | 862 | 321 | 7 | 7 | 7 | 7 |
| Timesteps | 52696 | 17544 | 26304 | 17420 | 17420 | 69680 | 69680 |

Following is experiments of the above-mentioned architectures. A performance of the proposed architecture was evaluated on seven popular multivariate datasets as depicted in Table 1. These datasets have been extensively used for benchmarking multivariate forecasting models and are publicly.

By default, the following data and model configuration is used:
Input Sequence length sl=512;
Patch length pl=16;
Stride s=8;
Batch size b=8;
Forecast sequence length fl∈{96, 192, 336, 720};
Number of Mixer layers nl=8;
feature scaler fs=2;
Hidden feature size hf=fs*pl (32);
Expansion feature size ef=fs*hf (64) and
Dropout do=0.1.
   Training is performed in a distributed fashion with 8 graphical processing units (GPUs), 10 computer processing units (CPUs), and 1000 gigabytes (GB) of memory. For ETT datasets, a lower hardware and model configuration with high dropout are used to avoid overfitting, as the dataset is relatively small (nl=3, do=0.7, ngpus=1). Supervised training is performed with 100 epochs. In self-supervised training, the backbone is first pretrained with 100 epochs. After that, in the finetuning phase, the backbone is frozen with weights for the first 20 epochs to train/bootstrap the head (also known as linear probing), and then, the entire network (backbone+head) is finetuned for the next 100 epochs. The final model is chosen based on the best validation score. Since overlapping patches have to be avoided in self-supervised methodology, the reduced patch length and stride is used with the same size there (i.e., pl=8, s=8). This further updates the hidden feature and expansion feature size by fs (i.e., hf=16, ef=32) for self-supervised methodology. Every experiment is executed with 5 random seeds (from 42-46) and the mean scores are reported. Standard deviation is also reported for the primary results. The mean squared error (MSE) and mean absolute error (MAE) are used as the standard error metrics.

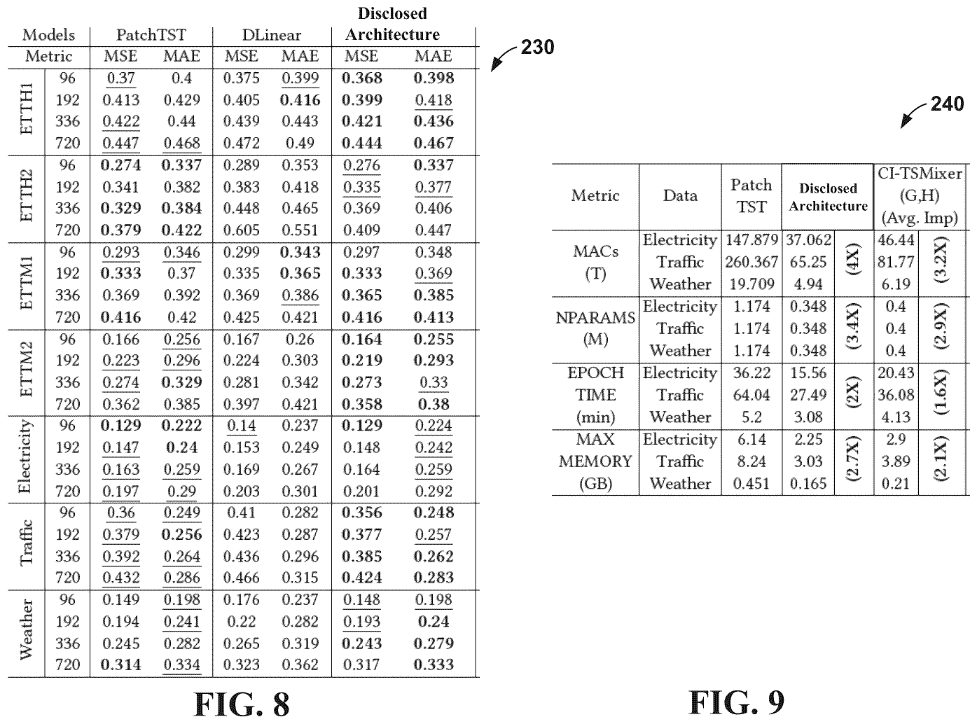

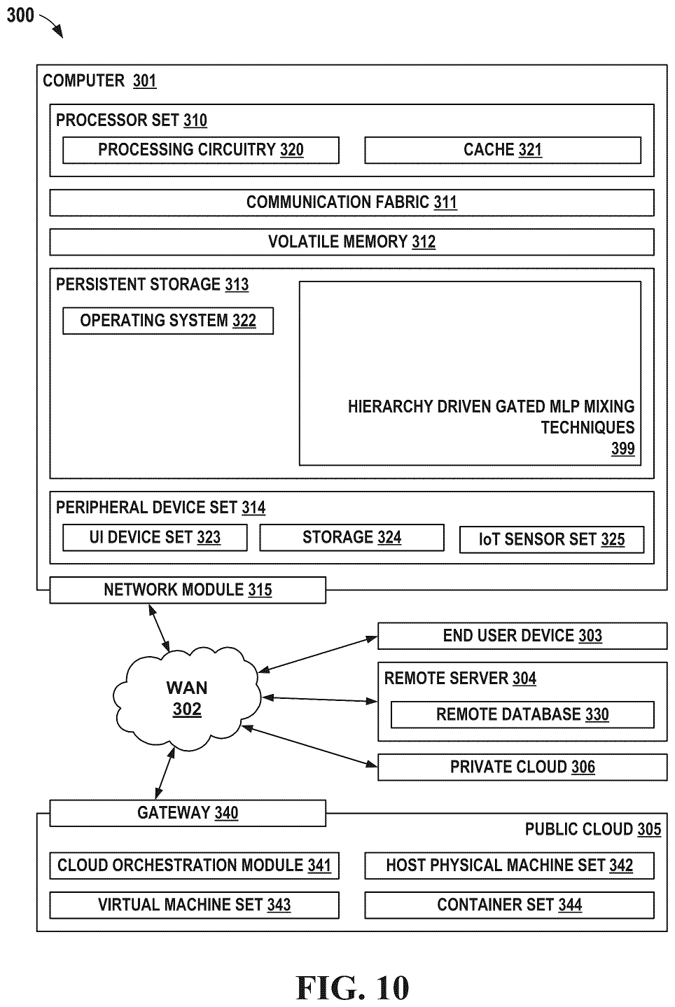

The experiments use DLinear and PatchTST as SOTA benchmarks follow the same data loading parameters followed in these benchmarks. FIG. 8 shows the reduction in Mean Square Error (MSE) and Mean Absolute Error (MAE) for the proposed method as compared to the SOTA benchmarks. Further, the architecture of this disclosure achieves improvement over transformer based models (Ex PatchTST) with a significant performance improvement with respect to training time and memory as depicted in FIG. 9. We show the computational improvement of the proposed approach on the following parameters: (i) Multiply-Add cumulative operations on the entire data per epoch (MACs), (ii) Number of model parameters (NPARAMS), (iii) Single EPOCH TIME and (iv) Peak GPU memory reached during a training run (MAX MEMORY).

Computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 7. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in hierarchy driven gated MLP Mixing techniques 399 in persistent storage 313.

Communication fabric 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in hierarchy driven gated MLP Mixing techniques 399 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301), and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-situation data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

What is claimed is:

1. A computer-implemented method comprising:
segmenting a time-series dataset from a plurality of sensors into a plurality of patches;
applying gated multilayer perceptron (MLP) mixing across different directions of the patched input time-series;
capturing local and global and interrelated correlations across the plurality of patches and within the plurality of patches; and
applying a patch-time aggregated hierarchy to guide lowest-level predictions based on aggregated hierarchy signals at a patch-level.

2. The computer-implemented method of claim 1, wherein the MLP mixing is channel independent.

3. The computer-implemented method of claim 1, wherein the MLP mixing uses layers that are stacked in linear fashion.

4. The computer-implemented method of claim 1, wherein the MLP mixing uses layers that are chained in a patch length context aware hierarchy fashion.

5. The computer-implemented method of claim 1, wherein the MLP mixing is mixed with respect to patches and features.

6. The computer-implemented method of claim 1, further comprising a pretraining task of masking random patches.

7. The computer-implemented method of claim 4, further comprising reconstructing the masked random patches.

8. The computer-implemented method of claim 1, further comprising a downstream task of forecasting values of the sensors.

9. The computer-implemented method of claim 1, further comprising a downstream task of executing regression analysis regarding values of the sensors.

10. The computer-implemented method of claim 1, further comprising a downstream task of classifying values of the sensors into one of a variety of predetermined classifications.

11. A system comprising:
a processor; and
a memory in communication with the processor, the memory containing instructions that, when executed by the processor, cause the processor to:
segment a time-series dataset from a plurality of sensors into a plurality of patches;
apply gated multilayer perceptron (MLP) mixing across different directions of the patched input time-series;
capture local and global and interrelated correlations across the plurality of patches and within the plurality of patches; and
apply a patch-time aggregated hierarchy to guide lowest-level predictions based on aggregated hierarchy signals at a patch-level.

12. The system of claim 11, wherein MLP the mixing is channel independent.

13. The system of claim 11, wherein the MLP mixing is mixed with respect to patches and features.

14. The system of claim 11, wherein the MLP mixing uses layers that are either stacked in linear fashion or chained in a patch length context aware hierarchy fashion.

15. The system of claim 11, the memory containing additional instructions that, when executed by the processor, cause the processor to execute a pretraining task of masking random patches.

16. The system of claim 15, the memory containing additional instructions that, when executed by the processor, cause the processor to reconstruct the masked random patches.

17. The system of claim 11, the memory containing additional instructions that, when executed by the processor, cause the processor to execute a downstream task of forecasting values of the sensors.

18. The system of claim 11, the memory containing additional instructions that, when executed by the processor, cause the processor to execute a downstream task of executing regression analysis regarding values of the sensors.

19. The system of claim 11, the memory containing additional instructions that, when executed by the processor, cause the processor to execute a downstream task of classifying values of the sensors into one of a variety of predetermined classifications

20. A computer program product comprising a computer readable storage medium having program instructions embodied therewith, the program instructions executable by a computer to cause the computer to:
segment a time-series dataset from a plurality of sensors into a plurality of patches;
apply gated multilayer perceptron (MLP) mixing across different directions of the patched input time-series;
capture local and global and interrelated correlations across the plurality of patches and within the plurality of patches; and
apply a patch-time aggregated hierarchy to guide lowest-level predictions based on aggregated hierarchy signals at a patch-level.
